(19) United States
(12) Patent Application Publication
(10) Pub. No.: US 2005/0282572 A1
(43) Pub. Date: Dec. 22, 2005

(54) Data transmission method, radio network controller and base station

(76) Inventors: Jeroen Wigard, Aalborg (DK); Marin Sikiric, Hasselby (SE); Preben Mogensen, Gistrup (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/533,785

(22) PCT Filed: Nov. 8, 2002
(86) PCT No.: PCT/FI02/00876

§ 371 Date: May 4, 2005

(51) Int. Cl. H04B 7/00

(52) U.S. Cl. 455/522

(57) ABSTRACT

The invention is related to a data transmission method in a telecommunication system. The method comprises determining the number of bit rate classes, setting bit rates for the bit rate classes, setting a maximum transmission power target, arranging resource requests into a queue, allocating resources according to the requests in the queue until the maximum power target is achieved.

### FIELD

The invention relates to a data transmission method in a telecommunication system.

### BACKGROUND

For the end user the most important thing in telecommunication networks is naturally that he can be satisfied with the end-to-end services he uses. In UMTS (Universal Mobile Telecommunication System) the quality of service is determined using a QoSt concept, in other words Quality of Service. An end-to-end service sets requirements regarding QoS. The requirements are mapped to the following hierarchical level, which in turn performs QoS mapping for the following level and so on. To make the mapping possible, the QoS requirements are classified.

For the end user, the impression of the connection quality typically relates to the delay experience. This is the main reason why the connection delay is the general separating characteristic between QoS classes. Another important characteristic is, for instance, a guaranteed bit rate, which in practice typically means bandwidth.

The problem is that at the same time, when the end user is being offered a service of a satisfying quality, the limited radio resources have to be used efficiently. To achieve this target, the bit rates have to be allocated economically: the bit rates have to be high enough to provide the required service but not unnecessarily high to avoid wasting of resources.

### BRIEF DESCRIPTION OF THE INVENTION

It is an object of the invention to provide an improved method to allocate bit rates especially for packet transmission. This is achieved by a data transmission method in a telecommunication system. The method comprises determining the number of bit rate classes, setting bit rates for the bit rate classes, setting a maximum transmission power target, arranging resource requests into a queue, allocating resources according to the requests in the queue until the maximum power target is achieved.

The invention also relates to a data transmission method in a telecommunication system, comprising determining the number of bit rate classes, setting bit rates for the bit rate classes, setting a maximum transmission power target, arranging resource requests into a queue, allocating resources according to the requests in the queue, if the maximum power target is not achieved when resources have been allocated to all the users in the queue increasing the bit rates on the basis of the queue until the maximum power target is achieved, if the resource requests cause too much load in relation to the maximum power target decreasing the required number of bit rates in a predetermined way.

The invention also relates to a radio network control comprising means for determining the number of bit rate classes, means for setting bit rates for the bit rate classes, means for setting a maximum transmission power target, means for arranging resource requests into a queue, means for allocating resources according to the requests in the queue until the maximum power target is achieved.

The invention also relates to a radio network control comprising means for determining the number of bit rate classes, means for setting bit rates for the bit rate classes, means for setting a maximum transmission power target, means for arranging resource requests into a queue, means for allocating resources according to the requests in the queue, means for increasing the bit rates on the basis of the queue until the maximum power target is achieved, means for decreasing the required number of bit rates in a predetermined way.

The invention also relates to a base station comprising means for arranging resource requests into a queue, means for allocating resources according to the requests in the queue.

The invention also relates to a base station comprising means for arranging resource requests into a queue, means for resources according to the requests in the queue, means for increasing the bit rates on the basis of the queue until the maximum target set for the transmission power is achieved, means for decreasing the required number of bit rates in a predetermined way.

Preferred embodiments of the invention are described in the dependent claims.

The method and system of the invention provide several advantages. A preferred embodiment of the invention offers the operator a possibility to control the separation of the Quality of Service classes. It is also possible to increase or decrease the bit rates and thus to adjust the load to the target set for the maximum transmission power. Thereby limited radio resources are used efficiently.

### LIST OF THE DRAWINGS

In the following, the invention will be described in greater detail with reference to the preferred embodiments and the accompanying drawings, in which

FIG. 1 shows a simplified example of a telecommunication system,

FIG. 2 is a flow chart,

FIG. 3 illustrates one example of a bit rate allocation method,

FIG. 4 illustrates another example of the bit rate allocation method,

FIG. 5 illustrates another example of the bit rate allocation method,

FIG. 6 shows an example of a Radio Network Controller,

FIG. 7 shows an example of a Base Station.

### DESCRIPTION OF EMBODIMENTS

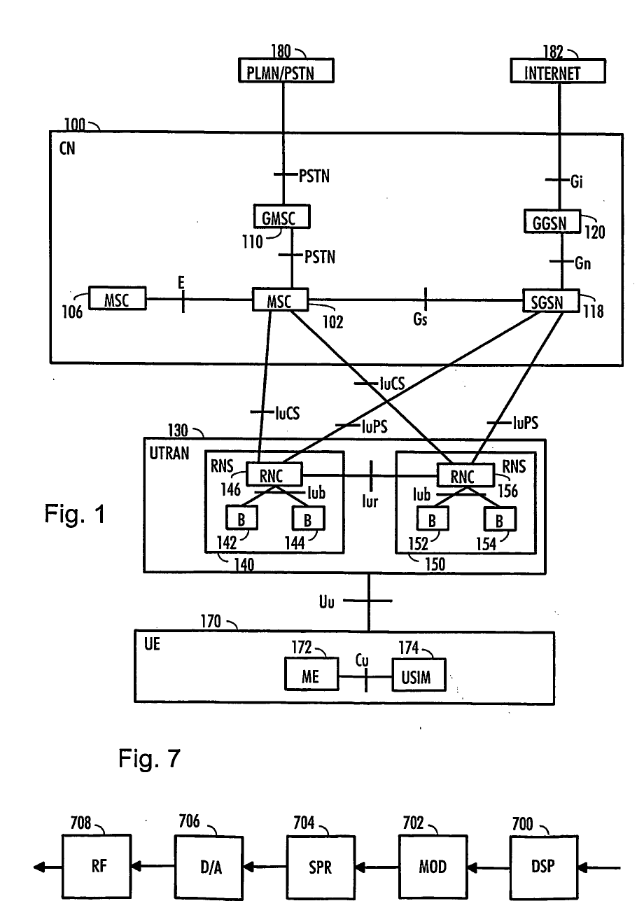

With reference to FIG. 1, examine an example of a data transmission system in which the preferred embodiments of the invention can be applied. The invention can be implemented in the RNC (Radio Network Controller) and/or BS (Base Station) and can e.g. be a part of RAN (Radio Access Network) for instance UTRAN (UMTS Terrestrial Radio Access Network) solution as well as IPRAN (Internet Protocol RAN).

In FIG. 1 the embodiments are described in a simplified radio system representing a Code Division Multiple Access, CDMA, system. Code Division Multiple Access is used nowadays for example in radio systems known at least by the names IMT-2000 (International Mobile Telecommunications 2000) and UMTS (Universal Mobile Telecommunications System). The embodiments are not, however, restricted to these systems given as examples but a person skilled in the art may apply the solution in other radio systems provided with the necessary properties.

FIG. 1 is a simplified block diagram describing the most important network elements of the radio system and the interfaces between them. The structure and function of the network elements are not described in detail because they are generally known.

The main parts of the radio system are a core network (CN) 100, a radio access network 130 and user equipment (UE) 170. The term UTRAN is an abbreviation from UMTS Terrestrial Radio Access Network, i.e. the radio access network belongs to the third generation and is implemented by wideband code division multiple access WCDMA. Generally, the radio system can also be defined as follows: the radio system consists of a user terminal, which is also called a subscriber terminal or a mobile station, and of a network part, which includes the fixed infrastructure of the radio system, i.e. a core network, a radio access network and a base station system.

A mobile services switching centre (MSC) 102 is the centre of the circuit-switched side of the core network 100. The mobile services switching centre 102 is used to serve the connections of the radio access network 130. The tasks of the mobile services switching centre 102 typically include switching, paging, user terminal location registration, handover management, collection of subscriber billing information, data encryption parameter management, frequency allocation management and echo cancellation.

The number of mobile services switching centres 102 may vary: a small network operator may have only one mobile services switching centre 102, whereas large core networks 100 may have several ones. FIG. 1 shows another mobile services switching centre 106 but for the sake of clarity its connections to other network elements are not illustrated.

Large core networks 100 may comprise a separate gateway mobile services switching centre (GMSC) 110, which is responsible for circuit-switched connections between the core network 100 and the external networks 180. The gateway mobile services switching centre 110 is located between the mobile services switching centres 102, 106 and the external networks 180. The external network 180 may be, for example, a public land mobile network PLMN or a public switched telephone network PSTN.

The core network 100 typically comprises other parts, too, such as a home location register HLR, which includes a permanent subscriber register and, if the radio system supports the GPRS, a PDP address (PDP=Packet Data Protocol), and a visitor location register VLR, which includes information on roaming of the user terminals 170 in the area of the mobile services switching centre 102. For the sake of clarity, all the parts of the core network are not shown in FIG. 1.

A serving GPRS support node (SGSN) 118 is the centre of the packet-switched side of the core network 100. The main task of the serving GPRS support node 118 is to transmit and receive packets with the user terminal 170 supporting packet-switched transmission, utilizing the radio access network 130. The serving GPRS support node 118 includes user information and location information on the user terminal 170.

A gateway GPRS support node (GGSN) 120 on the packet-switched side corresponds to the gateway mobile services switching centre 110 of the circuit-switched side, with the exception that the gateway GPRS support node 120 has to be able to route outgoing traffic from the core network 100 to external networks 182, whereas the gateway mobile services switching centre 110 typically routes only incoming traffic. In the example, the external networks 182 are represented by the Internet, via which a considerable part of wireless telephone traffic can be transmitted in the future.

The radio access network 130 consists of radio network subsystems 140, 150. Each radio network subsystem 140, 150 consists of radio network controllers (RNC) 146, 156 and B nodes 142, 144, 152, 154. The B node is rather an abstract concept and therefore frequently replaced by the term ‘base station’.

The radio network controller 146, 156 is usually responsible for the following tasks, for example: management of the radio resources of the base transceiver station or B-node 142, 144, 152, 154, intercell handover, measurement of time delays on the uplink, implementation of the operation and management interface, and management of power control.

The radio network controller 146, 156 includes at least one transceiver. One radio network controller 146, 156 may serve one cell or several sectorized cells. The cell diameter may vary from a few metres to dozens of kilometres. The radio network controller 146, 156 is often deemed to include a transcoder, too, for performing conversion between the speech coding format used in the radio system and the speech coding format used in the public switched telephone system. In practice the transcoder, however, is usually located in the mobile services switching centre 102. The radio network controller 146, 156 is usually responsible for the following tasks, for example: measurements on the uplink, channel coding, encryption and scrambling coding.

The user terminal 170 consists of two parts: mobile equipment (ME) 172 and a UMTS subscriber identity module (USIM) 174. The user terminal 170 comprises at least one transceiver for establishing a radio connection to the radio access network 130. The user terminal 170 may include at least two different subscriber identity modules. In addition, the user terminal 170 comprises an antenna, a user interface and a battery. Nowadays various kinds of user terminals 170 are available, e.g. terminals that are installed in a car and portable terminals. The user terminals 170 also have properties similar to those of a personal computer or a portable computer.

The USIM 174 includes information on the user and on data security, e.g. an encryption algorithm, in particular.

It is obvious to a person skilled in the art that the interfaces included in the radio telecommunications system are determined by the hardware implementation and the standard used, for which reason the interfaces of the system may differ from those shown in FIG. 1. In the UMTS, the most important interfaces are the Iu interface between the core network and the radio access network, which is divided into the IuCS (CS=Circuit Switched) interface of the circuit-switched side and the IuPS (PS=Packet Switched) interface of the packet-switched side, and the Uu interface between the radio access network and the user terminal. The interface defines what kind of messages different network elements may use to communicate with one another. The object of the standardisation of interfaces is to enable function between network elements of different producers. In practice, however, some of the interfaces are producer-specific.

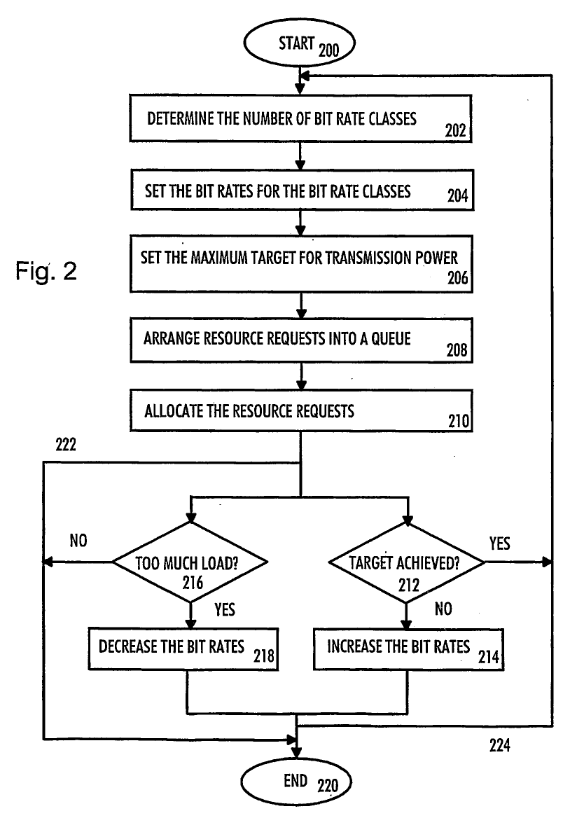

The FIG. 2 shows a flow chart of a preferred embodiment of the bit rate allocation method that uses the QoS classification according to the invention. The embodiment is based on some QoS parameters such as Allocation Retention Priority (ARP), Traffic Class (TC) or Traffic Handling Priority (THP), but it is possible to use other suitable parameters as well. The method is especially suitable for packet transfer.

In the following, some parameters that can be used in the method are explained briefly.

Traffic Class, TC, parameter means typically the same as the UMTS QoS (Quality of Service) classes. There are four different QoS, or TC, classes: conversational class, streaming class, interactive class and background class. The main distinguishing factor between these classes is how delay sensitive the traffic is. For instance, conversational class is meant for traffic which is remarkably delay sensitive, while background class is meant for traffic which tolerates even relatively long delays.

Traffic Handling Priority, THP is a UMTS parameter which specifies the relative importance of handling all SDUs belonging to the UMTS bearer compared to the SDUs of other bearers. SDU, i.e. Service Data Unit, in other words an information unit passed from one protocol layer to another. The Traffic Handling Priority parameter is used for differentiating between bearer qualities. This parameter is available only for the interactive traffic class.

The Allocation Retention Priority, ARP, parameter is used for differentiating between bearers when performing allocation and retention of a bearer. In situations where resources are scarce, the relevant network elements can use the Allocation/Retention Priority to prioritize bearers with a high Allocation/Retention Priority over bearers with a low Allocation/Retention Priority when performing admission control.

The end-to-end QoS in UMTS is supported by several bearer services: first level service, local bearer service, UMTS bearer service and external bearer service. The UMTS bearer service consists of RAB (Radio Access Bearer) service and the core network bearer service. The air interface, the UTRAN and the Iu interface belong to the RAB service. UMTS specifications define four QoS classes corresponding to various traffic requirements, typically delay tolerance. The QoS classes are: conversational class for phone calls, streaming class for on-line audio and video connections, interactive class for web browsing, etc. and background class for different data applications such as packet-data.

More details about QoS can be found in the literature and standards of the field.

The method begins in block 200. In block 202 the number of bit rate classes are determined. The number of the classes depends on the current need and system. The bit rates, and thus the amount of bit rate classes, are usually determined by the specifications and/or circumstances, such as available capacity.

In block 204 the bit rates for the bit rate classes are set. The bit rates are usually set by the operator within the limits of the available capacity. They can thus be changed according to the current system. In this application, these bit rates are called minimum bit rates in this application. The minimum bit rate is set to be class-specific or general, i.e. the same for all classes. It is also possible to set both a common or general minimum bit rate for all classes, and in addition, class-specific minimum bit rates. There are other possibilities, too. Attention has to be paid to the fact that bit rates tend to grow according to technical development. Nowadays typical bit rates are 32 kbps, 64 kbps and 128 kbps. If these bit rates are used, the general minimum bit rate can be for instance 32 kbps. The users are divided into classes typically according to the price they pay for a connection.

The maximum transmission power target is set in block 206. In CDMA systems, such as UMTS, power control is a key issue, because many users employ the same frequency and thus cause interference to each other. This is why a maximum transmission power target is set. On the other hand, in cellular systems transmission power defines the size of the cell. In addition, power control is important in the CDMA-networks because of the near-far problem. The target is system-dependent and it is determined by the operator.

In block 208 the resource requests are arranged into a queue. The users can be arranged in many different ways. For example, the user who first asked for radio resources is the first in the queue. The principles according to which the users are put in order vary according to the current needs.

The resources are allocated on the basis of the requests in the queue in block 210. Typically, the resources are allocated according to the queue order. In other words, the first to get resources is the first in the queue. The Allocation process can of course be arranged in other ways, too. Allocation continues until the maximum power target is achieved.

Arrow 222 depicts one possible embodiment of the invention in which bit rates are only allocated, not increased or decreased. The load control has to be implemented in some other way.

In another preferred embodiment of the invention it is possible to change, to increase or decrease, bit rates. In block 212 it is checked, whether the maximum power target is achieved or not. If it is not achieved, the bit rates are increased in block 214 on the basis of the queue until the maximum power target is achieved. Typically, the bit rate of the user who is first in the queue is raised first, the bit rate of the second user, is raised next, etc.

In block 216 it is checked, whether the resource requests cause too much load in relation to the maximum power target. If the load is too high, the bit rates are decreased in block 218. The reduction is made, for instance, according to the following rules: bit rates higher than the minimum bit rate of their class or higher than the common minimum bit rate are decreased first and users whose a bit rate is equal to the minimum are transferred to the control channel (CCH). Control Channel is a logical radio channel that carries system management messages between a base transceiver station and a mobile station. A mobile communication network may have several control channels, for example a broadcast control channel (BCCH), common control channel (CCCH) and associated control channel (ACCH). In this method, the typically used channels are RACH (Random Access Channel) and FACH (Forward Access Channel).

The decreasing continues until the common load is below the transmission power target.

The method ends in block 220. Arrow 224 shows one possible way of repeating the method.

Next, the preferred embodiments are explained in further detail by means of examples. In the following examples, the user class is based on the QoS parameter called ARP, Allocation Retention Priority. There are three bit rate classes, called gold, silver and bronze, of which the gold class has the highest and the bronze the lowest minimum bit rate. The examples relate to packet transmission. The concept of the minimum bit rate refers to the maximum bit rate in a TFCS set. The TFCS set is a set of transport format combinations to be used by the mobile station, which allows bit rates to be chosen on a TTI basis. TTI, Transmission Time Interval, is equal to the frame length. In the examples, a general minimum bit rate value of 32 kbps and several class-specific minimum bit rates have been set: for gold class 128 kbps, for silver class 64 kbps and for bronze class 32 kbps.

For the sake of simplicity, the examples, do not take into account that usually different users, even if they use the same kbit rate, need different amounts of power due to different radio conditions.

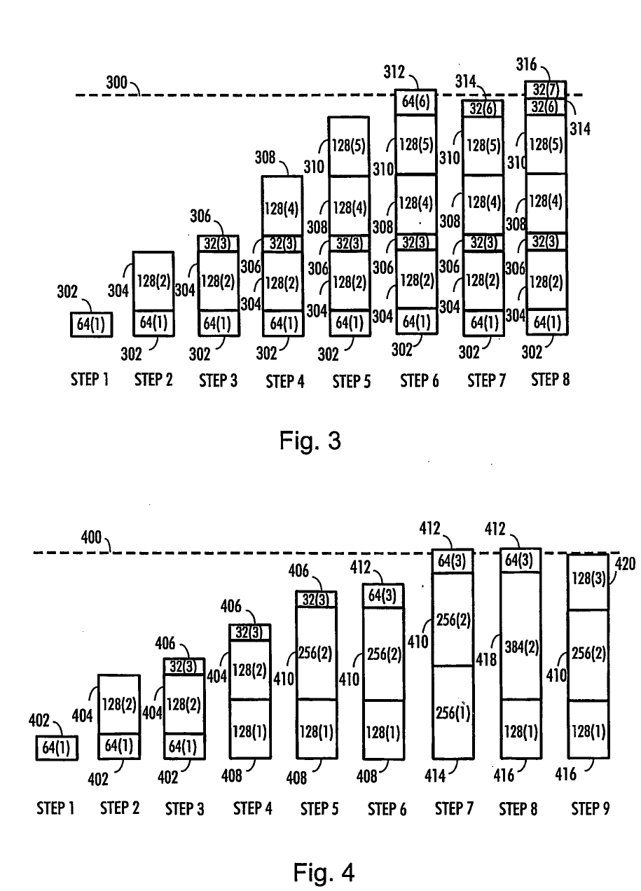

FIG. 3 illustrates one example of the bit rate allocation method. The transmission power target is shown by dotted line 300. The resource requests are in the queue as follows: users number 2, 4 and 5 are gold users, users number 1 and 6 are silver users and users number 3 and 7 are bronze users.

In the first step, the first user in the queue is allocated his minimum bit rate 64 kbps 302. Then, in step 2, the second user is allocated his minimum bit rate 128 kbps 304. The process continues until the users number 3, 4 and 5 are allocated their bit rates, marked in FIG. 3 with numbers 306, 308 and 310. The user 3 has a bit rate of 32 kbps and the users 4 and 5 have bit rates of 128 kbps. Then it is noticed that the system cannot accept the next user, number 6, marked in FIG. 3 with number 312, because he needs too much capacity, 64 kbps. Then the user is offered as high a bit rate as possible, in this case 32 kbps, marked in FIG. 3 with number 314. 32 kbps is in this example the general minimum bit rate. There is still another user in the queue, user number 7, but there is not enough space for him either in the system, therefore an attempt is made to allocate him the general minimum bit rate of 32 kbps. This is shown in FIG. 3 with number 316. This time, there is no space with that bit rate either, so this user has to wait for space to become available or he is transferred to a control channel.

FIG. 4 illustrates another example of the bit rate allocation method. This example shows how bit rates can be increased if the transmission power target 400 is not yet achieved and all the users in the queue are already allocated their resources. In the queue, there are three users: the first one is a silver user, the second is a gold user and the third is a bronze user.

In the beginning, the first user is allocated the minimum bit rate of his class, 64 kbps 402. Then the second user is allocated the minimum bit rate of his class, 128 kbps 404. The allocation process continues until all the users in the queue are allocated their resources. In this example, the last user is the third user, who is allocated the minimum bit rate of his class 32 kbps 406.

After this, the bit rate increase starts in step 4. The bit rate is increased in this example in the order of the queue. In other words, the first user is the first one to get the higher bit rate of 128 kbps marked in FIG. 4 with number 408. Next one is the second user, who gets the new bit rate of 256 kbps number 410.

The transmission power target is not yet achieved, so the increase process continues in step 6. The third user is given the higher bit rate of 64 kbps marked in FIG. 4 with number 412. The process continues in the next step where the first user gets the higher bit rate again. The new bit rate is 256 kbps marked with number 414. Then it is noticed that the target is exceeded, so the algorithm transfers a part of the bit rate of the first user to the second user, whereby the second user gets higher bit rate of 384 kbps 418 and the bit rate of the first user is 128 kbps 416. The target still remains exceeded and therefore in step 9 the algorithm transfers a part of the bit rate of the second user to the third user. The third user gets a new bit rate of 128 kbps marked with number 420, and the bit rate of the second user is 256 kbps marked with number 410. Now the whole capacity is used and all the users in the queue have been allocated their bit rates.

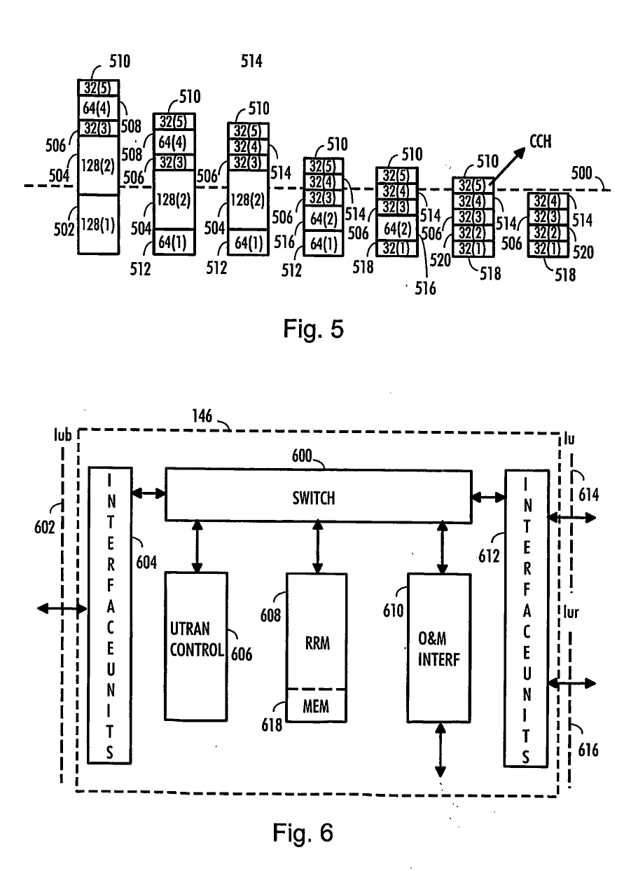

FIG. 5 depicts another example of the bit rate allocation method. This example shows, how bit rates can be decreased if the transmission power target 500 is exceeded. In the beginning there are 5 users who has been allocated the minimum bit rate of their classes or higher bit rates. The first user has a bit rate of 128 kbps number 502, the second also has 128 kbps 504, the third 32 kbps 506, the fourth 64 kbps 508 and the fifth 32 kbps 510. The general minimum bit rate used is 32 kbps. This is the absolute minimum, below which the rate cannot go.

The first user is a silver user and therefore has a minimum bit rate of 64 kbps. Thus the first one to get a lower bit rate is the first user. His new bit rate is 64 kbps, which is the minimum bit rate of his class. This is marked in FIG. 5 with number 512. There is still too much load and therefore the decreasing process has to continue. In step 2, the fourth user, who is a silver user and has the minimum bit rate of his class, gets a lower bit rate of 32 kbps number 514.

In the next step, step 3, there are two options: the first user again, who now has the minimum bit rate of his class or the second user, who has the minimum bit rate of his class. This time the gold user, user number 2 is chosen and he is allocated a lower bit rate of 64 kbps marked in FIG. 5 with number 516. Next user 1 is given a lower bit rate of 32 kbps 518. Then user 2 is given a new lower bit rate, which is also 32 kbps. Also the user 2 is given a new lower bit rate of 32 kbps marked with the number 520. Now, in step 5 the algorithm notices that all the users have the same bit rate, the general minimum and thus the bit rate cannot be reduced anymore. There is still too much load and therefore one user has to be removed to another channel, typically to a control channel (CCH). A mobile communication network may have several control channels, for example a broadcast control channel (BCCH), common control channel (CCCH) and associated control channel (ACCH). In this method, the typically used channels are RACH (Random Access Channel) and FACH (Forward Access Channel).

After this, the load is below the transmission power target and the allocation process is completed.

It is obvious that the increasing and decreasing processes can also be combined.

There is also a radio link aspect in the bit rate allocation described above, since each link has its maximum power that determines the borders of the cell. The transmission power is thus set in the radio network planning process. The radio coverage depends on the maximum of the allocated power per link for a certain load factor. If the maximum power on every link is equal for all the bit rates, then the coverage area for low bit rates is larger than for high bit rates. There are two options for taking this into consideration in the bit rate allocation: either to give the maximum power per link to the different user classes in such a way that the coverage area or cell size is the same for all or to accept the different sizes of the coverage areas for the different bit rates and give gold users a lower bit rate at the cell border. Cell coverage is a problem mainly in large cells.

FIG. 6 shows a simplified functional example of a radio network controller (RNC) where the embodiments of the data transmission method can be accomplished. For a person skilled in the art it is clear that the radio network controller can differ from what is depicted in FIG. 6.

RNC is, as mentioned above, the switching and controlling element of UTRAN. UTRAN is the network element of the UMTS network. The switcing unit 600 takes care of the connection between the core network and the user equipment. The radio network controller is located between the Iub 602 and Iu 614 interfaces. There is also an interface Iur for inter-RNC transmission 616. The blocks 604 and 612 depict interface units between the radio network controller and other network. The precise implementation of the radio network controller is producer-dependent.

The functionality of the radio network controller can be classified into two classes: UTRAN radio resource management 608 and control functions 606. An operation and management interface function 610 serves as a medium for information transfer to and from network management functions. The radio resource management is a group of algorithms used to share and manage the radio path connection so that the quality and capacity of the connection are adequate. The most important radio resource management algorithms are handover control, power control, admission control, packet scheduling, and code management. The UTRAN control functions take care of functions related to the set-up, maintenance and release of a radio connection between base stations and user equipment.

The radio network controller performs the actions needed in the bit rate allocation method described above such as forming the user queue and increasing or decreasing the bit rates. This process also requires a memory unit 618 where for example the information on minimum bit rates is stored.

The disclosed functionalities of the described embodiments of the data transmission method can be advantageously implemented by means of software that typically locates in the radio resource management block 608 of the radio network controller. The implementation solution can also be for instance an ASIC (Application Specific Integrated Circuit) component.

FIG. 7 shows a simplified example of a transmitter of a base station, or a node B, where the embodiments of the data transmission method can also be implemented. For a person skilled in the art it is clear that the transceiver can differ from what is depicted in FIG. 7. In this example, the network offers the base station the following information: the number of bit rate classes, bit rates of the bit rate classes and the maximum transmission power target.

Block 700 is a DSP, Digital Signal Processor, which for example codes, ciphers and interleaves data before transmitting it. The bit rate allocation according to the embodiment of the invention can be carried out in the DSP block, for instance as a part of packet scheduling, especially in the HSDPA (High Speed Packet Access).

Block 702 is a modulator modulating a carrier with data. There are many different modulation methods and the current radio system determines which one will be used. Basically, the modulation methods are divided into three classes: amplitude modulation, frequency modulation and phase modulation. The names denote the signal characteristic that changes and thus carries the information. Naturally, the modulation methods can also be combined. More about modulation and different modulation methods can be read in the literature of the art.

Block 704 is a spreader which in wideband systems spread the signal spectrum on a wider band. The spreading is typically performed by multiplying a modulated narrowband signal by a pseudo-random code. It is obvious that if the system is a narrowband system, this block is not included in the transmitter. The spread spectrum systems are widely known in the field, and therefore they are not explained here in further detail.

Block 706 is a digital-to-analog converter which transforms the signal to an analog form. The converters are also known by a person skilled in the art.

Block 708 is a radio frequency block which usually comprises an upconverter that converts a base band signal to the intermediate frequency or straight to the radio frequency. The radio frequency block usually also comprises a power amplifier for amplifying the signal to the needed transmitting power. The signal is then taken to an antenna, not shown in FIG. 7.

The disclosed functionalities of the described embodiments of the data transmission method can be advantageously implemented by means of software that typically locates in the digital signal processor 700. The implementation solution can also be for instance an ASIC (Application Specific Integrated Circuit) component.

Even though the invention is described above with reference to an example according to the accompanying drawings, it is clear that the invention is not restricted thereto but it can be modified in several ways within the scope of the appended claims.

1. A data transmission method in a telecommunication system, the method comprising:
determining the number of bit rate classes;
setting bit rates for the bit rate classes;
setting a maximum transmission power target;
arranging resource requests into a queue;
allocating resources according to the requests in the queue until the maximum power target is achieved.

2. A data transmission method in a telecommunication system, the method comprising:
determining the number of bit rate classes;
setting bit rates for the bit rate classes;
setting a maximum transmission power target;
arranging resource requests into a queue;
allocating resources according to the requests in the queue;
if the maximum power target is not achieved when resources have been allocated to all the users in the queue,
increasing the bit rates on the basis of the queue until the maximum power target is achieved;
if the resource requests cause too much load in relation to the maximum power target,
decreasing the required number of bit rates in a predetermined way.

3. The method of claim 1, further comprising determining the bit rate classes on the basis of the required Quality of Service, QoS.

4. The method of claim 1, further comprising setting the bit rate classes on the basis of a Quality of Service, QoS, parameter ARP, Allocation Retention Priority.

5. The method of claim 2, further comprising: when the maximum power threshold is exceeded the bit rate decreasing by allocating to the user a general minimum bit rate.

6. The method of claim 2, further comprising: when the maximum power threshold is exceeded the bit rate decreasing by allocating to the user a class-specific minimum bit rate.

7. The method of claim 2, wherein the decreasing of the bit rate starts form the user who has a bit rate higher than the general minimum bit rate and the lowest priority, followed by the user who has a bit rate higher than the class specific minimum bit rate and the lowest priority.

8. The method of claim 2, further comprising: if a general minimum bit rate or a class specific minimum bit rate is allocated to the users and the load remains too high, the required number of users are transferred to the control channel.

9. A radio network controller
comprising:
means for determining the number of bit rate classes;
means for setting bit rates for the bit rate classes;
means for setting a maximum transmission power target;
means for arranging resource requests into a queue;
means for allocating resources according to the requests in the queue until the maximum power target is achieved.

10. A radio network controller comprising:
means for determining the number of bit rate classes;
means for setting bit rates for the bit rate classes;
means for setting a maximum transmission power target;
means for arranging resource requests into a queue;
means for allocating resources according to the requests in the queue;
means for increasing the bit rates on the basis of the queue until the maximum power target is achieved;
means for decreasing the required number of bit rates in a predetermined way.

11. The radio network controller of claim 10, further comprising means for determining the bit rate classes on the basis of the required Quality of Service, QoS.

12. The radio network controller of claim 10, further comprising means for setting the bit rate classes on the basis of a Quality of Service, QoS, parameter ARP, Allocation Retention Priority.

13. The radio network controller of claim 10, further comprising means for decreasing the bit rate by allocating a general minimum bit rate to a user.

14. The radio network controller of claim 10, further comprising means for decreasing the bit rate by allocating the class specific minimum bit rate to a user.

15. The radio network controller of claim 10, further comprising means for starting the decreasing of the bit rate from the user who has a bit rate higher than the general minimum bit rate and the lowest priority, followed by the user who has a bit rate higher than the class specific minimum bit rate and the lowest priority.

16. The radio network controller of claim 10, further comprising means for transferring the needed number of users onto the control channel.

17. A base station comprising:
means for arranging resource requests into a queue;
means for allocating resources according to the requests in the queue.

18. A base station comprising:
means for arranging resource requests into a queue;
means for allocating resources according to the requests in the queue;
means for increasing the bit rates on the basis of the queue until the maximum target set for the transmission power is achieved;
means for decreasing the required number of bit rates in a predetermined way.

19. A radio network controller configured to:
determine the number of bit rate classes;
set bit rates for the bit rate classes;
set a maximum transmission power target;
arrange resource requests into a queue;
allocate resources according to the requests in the queue until the maximum power target is achieved.

20. A radio network controller configured to:
determine the number of bit rate classes;
set bit rates for the bit rate classes;
set a maximum transmission power target;
arrange resource requests into a queue;
allocate resources according to the requests in the queue;
increase the bit rates on the basis of the queue until the maximum power target is achieved;
decrease the required number of bit rates in a predetermined way.

21. A base station configured to:
arrange resource requests into a queue;
allocate resources according to the requests in the queue.

22. A base station configured to:
arrange resource requests into a queue;
allocate resources according to the requests in the queue;
increase the bit rates on the basis of the queue until the maximum target set for the transmission power is achieved;
decrease the required number of bit rates in a predetermined way.
